(19) United States
(12) Patent Application Publication
(10) Pub. No.: US 2026/0196405 A1
(43) Pub. Date: Jul. 9, 2026

(54) TRANSFORMER FOR A VOLTAGE CONVERTER

(71) Applicant: VALEO ELECTRIFICATION, Cergy Pontoise (FR)

(72) Inventors: Amaury ROUET, Cergy Pontoise (FR); Wendell DA-CUNHA-ALVES, Cergy Pontoise (FR); Roger DENIOT, Cergy Pontoise (FR); Massourang DIALLO, Cergy Pontoise (FR); Baptiste PARIGOT, Cergy Pontoise (FR); Julien LEVEQUE, Cergy Pontoise (FR)

(73) Assignee: VALEO ELECTRIFICATION, Cergy Pontoise (FR)

(21) Appl. No.: 19/133,118

(22) PCT Filed: Nov. 28, 2023
(86) PCT No.: PCT/EP2023/083432

§ 371 Date: May 27, 2025

(30) Foreign Application Priority Data
Dec. 8, 2022 (FR) FR2212955

(51) Int. Cl. H01F 27/30; B60R 16/033; H01F 27/02; H01F 27/04; H01F 38/14; H02M 7/00

(52) U.S. Cl. CPC H01F 27/306; B60R 16/033; H01F 27/022; H01F 27/04; H01F 38/14; H02M 7/003

(57) ABSTRACT

An electronic component including a housing, a magnetic circuit and two electrical conductors, each of which has a portion arranged around the same part of the magnetic circuit, each of the portions forming, between a first end and a second end, a winding, these two windings being inductively coupled to one another via the magnetic circuit. A support for the two electrical windings is arranged between the electrical conductors and the portion of the magnetic circuit. The support incorporates a system for holding on to the housing, in particular to the body of the housing.

The present invention relates to an electronic component comprising a magnetic circuit, and at least two electrical conductors each having a portion arranged around one and the same part of the magnetic circuit, each of said portions forming a winding between a first and a second end, these two windings being inductively coupled to one another via the magnetic circuit.

Such an electronic component defines, for example, a three-phase transformer for an isolated voltage converter, such a voltage converter being, for example, incorporated into a component for supplying electric power to a vehicle electrical energy storage unit, also referred to as a “charger” for this electrical energy storage unit. The electrical energy storage unit is, for example, a battery, which can have a nominal voltage greater than 60 V, for example greater than or equal to 300 V, 400 V, 800 V, or even 1000 V. The voltage converter receives, for example, an AC voltage from an electrical network and provides the battery with a DC voltage. This converter may convey a power greater than 5 kW, for example greater than 7 kW, for example greater than 11 kW, in particular of 22 kW or more.

An electronic component forming, for example, such a transformer comprises in a known manner:
a casing,
a magnetic circuit,
two electrical conductors each having a portion arranged around one and the same part of the magnetic circuit, each of said portions forming a winding between a first and a second end, these two windings being inductively coupled to one another via the magnetic circuit, and
a support for the two electrical windings, arranged between said electrical conductors and said portion of the magnetic circuit.

It is known practice to hold the magnetic circuit on the casing by means of an external electronic board to which the electrical conductors are connected. This has the disadvantage of requiring the electronic board to be attached above the transformer and gives rise to space constraints.

There is a need to remedy the aforementioned drawbacks. The invention seeks to address this need and does so, according to one of its aspects, by means of an electronic component, comprising:
a magnetic circuit,
two electrical conductors each having a portion arranged around one and the same part of the magnetic circuit, each of said portions forming a winding between a first and a second end, these two windings being inductively coupled to one another via the magnetic circuit, and
a support for the two electrical windings, arranged between said electrical conductors and said portion of the magnetic circuit, characterized in that the support incorporates a holding system for holding on the casing, in particular on a body of the casing.

According to the invention, the support for the electrical conductors has an additional function, such that it holds itself on the casing of the electronic component. This reduces the number of parts within the electronic component, and therefore its cost and size. It is also not necessary to place an electronic board above the electronic component to attach it indirectly to the casing.

The system for holding the support may comprise at least one pin, notably a single pin, protruding relative to the rest of the support.

The pin may have a cruciform section perpendicular to the longitudinal axis of the sup-port. Such a shape can make it possible for each arm of the cross to have a constant thick-ness while reducing the mass of the pin.

The pin may be forcibly received in an opening provided in the casing, notably in the body of the casing, in such a way as to hold the support on the casing. The magnetic circuit and the support(s) for electrical conductors are arranged, for example, in the casing, with said casing being filled with a resin that is then polymerized in order to immobilize the inside of the casing. The support may be thus held on the casing even when the resin has not yet polymerized.

The casing may comprise the body and a cover closing off the body. The body comprises, for example, a bottom wall and a side wall extending from the bottom wall and interposed between the bottom wall and the cover. The cover may have a plate shape.

The support may comprise a wall defining a hollow cylinder, in particular of circular cross section, around which the electrical windings are arranged, and the pin may extend along the axis of this cylinder.

The support may comprise three rims offset along the axis of the cylinder, such that one of the electrical windings is arranged between the first and the second rim and such that the other of the electrical windings is arranged between the second and the third rim, the pin extending axially away from the rest of the support, from the third rim. In other words, the two electrical windings supported by a support for electrical conductors may follow one another along this support, without overlapping in planes perpendicular to the longitudinal axis of this support.

Each electrical conductor is, for example, made of Litz wire.

In all of the above, the support may be made in one piece with the system for holding on the casing, being for example made of, for example, plastic such as polybutylene terephthalate (PBT), or polyamide (PA).

The support may also incorporate a holding system for holding on the magnetic circuit, in particular one or more blocks protruding relative to the rest of the support, the holding system for holding on the casing and the holding system for holding on the magnetic circuit being or not being circumferentially offset.

Each block may define a surface coming into contact with a surface of a base of the magnetic circuit. The surfaces of the block and of the base which come into contact may be flat.

The holding system may comprise at least two blocks, notably exactly two blocks, each block protruding relative to the rest of the support.

The interaction between the two blocks and the base may ensure that the support is rotatably immobilized on the magnetic circuit.

The pin(s) and the block(s) may extend axially away from the rest of the support from the third rim. Thus, the system for holding on the casing and the system for holding on the magnetic circuit may implement reliefs extending along the axis of the support away from the rest of the support.

In all of the above, the electronic component may define a transformer for an isolated voltage converter.

The transformer is, for example, a three-phase transformer for an isolated voltage converter, comprising three supports for electrical windings, each support being arranged around a portion of the magnetic circuit and supporting two windings inductively coupled to one another via the magnetic circuit, the supports defining in particular a geometric pattern of an equilateral triangle.

Each support thus bears two windings which are inductively coupled to one another and which together define one phase of the three-phase transformer.

The arrangement of the three supports for electrical windings in the form of an equilateral triangle may make it possible to guarantee that electrical parameters such as the inductances of the electrical windings are balanced and to reduce the magnetic volume. Each electrical winding support may incorporate such a holding system. Alternatively, only some supports, notably two, incorporate such a holding system, and others, notably one, do not.

In this case, and as already mentioned, each holding system may be formed by a single pin protruding relative to the rest of the support.

The magnetic circuit may be made up of two parts, each part defining a base supporting pins, superposed in pairs when these two parts are assembled, and the superposition of two studs defines the portion of the magnetic circuit on which a support for two electrical windings is mounted.

When all or some of the supports for electrical windings comprise a holding system for holding on the casing and a holding system for holding on the magnetic circuit, these holding systems may be arranged relative to one another in such a way as to immobilize the magnetic circuit relative to the casing. The combination of the systems for holding on the casing and the systems for holding on the magnetic circuit may thus allow the magnetic circuit to be held on the casing by means of the supports for electrical windings.

The invention also relates, according to another of its aspects, to a component for supplying electric power to a vehicle electrical energy storage unit, comprising the transformer defined above. The electrical energy storage unit is, for example, a battery which can have one of the above nominal voltages.

The invention will be better understood upon reading the following description of non-limiting embodiments thereof:

FIG. 1 schematically shows part of the electrical circuit of a component for supplying electric power to a vehicle electrical energy storage unit,

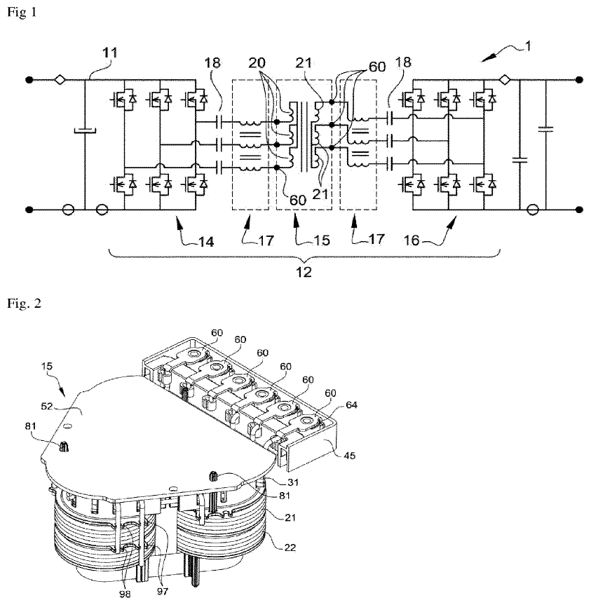

FIG. 2 shows in elevation an example of a three-phase transformer that can be used in the circuit of FIG. 1,

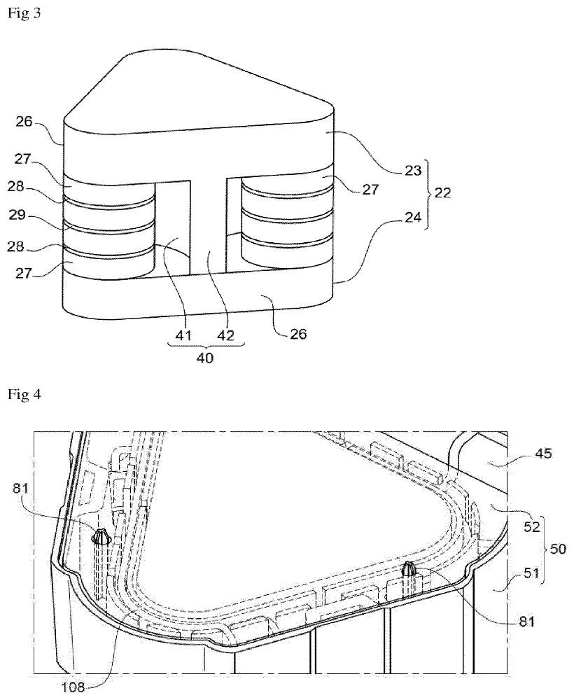

FIG. 3 shows, on its own, the magnetic circuit of the three-phase transformer of FIG. 2,

FIG. 4 partially shows the three-phase transformer of FIGS. 2 and 3 when the cover of the casing is removed,

FIG. 5 shows a detail of an example of a system for holding the cover of the casing of the transformer on the support,

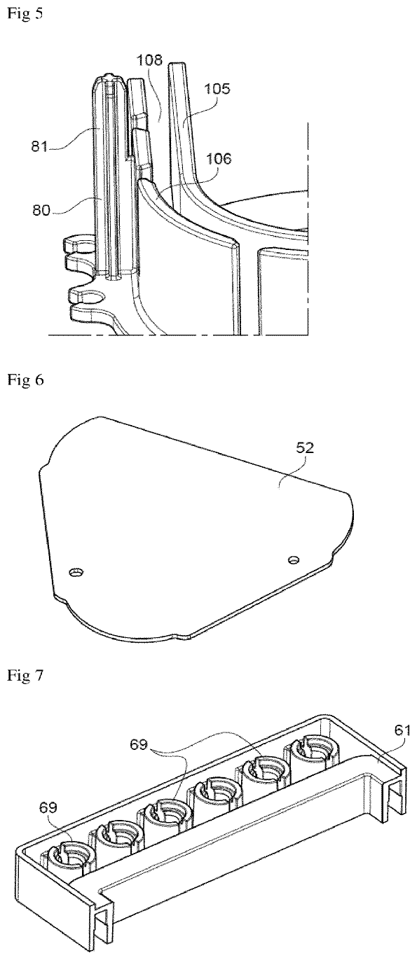

FIG. 6 shows the cover of the casing of FIG. 4,

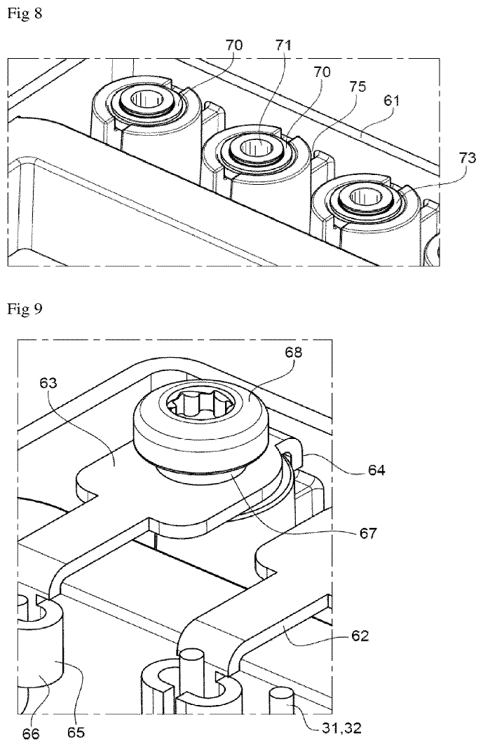

FIG. 7 shows, on its own, the body of the terminal block visible in FIG. 2,

FIG. 8 shows the body of FIG. 7 in which inserts are arranged,

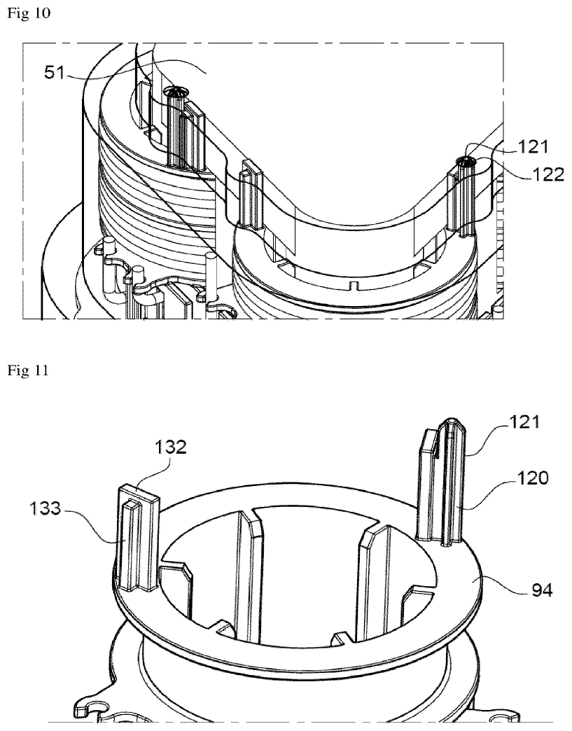

FIG. 9 shows the terminal block of FIGS. 7 and 8 with an electrically conductive bar and screw,

FIG. 10 shows the face of the transformer which is opposite that shown in FIG. 4,

FIG. 11 is a view of the support for electrical conductors of the transformer from the same side as FIG. 10 and shows the system for holding the support on the magnetic circuit and the system for holding the support on the body of the casing of the transformer which are borne by this support,

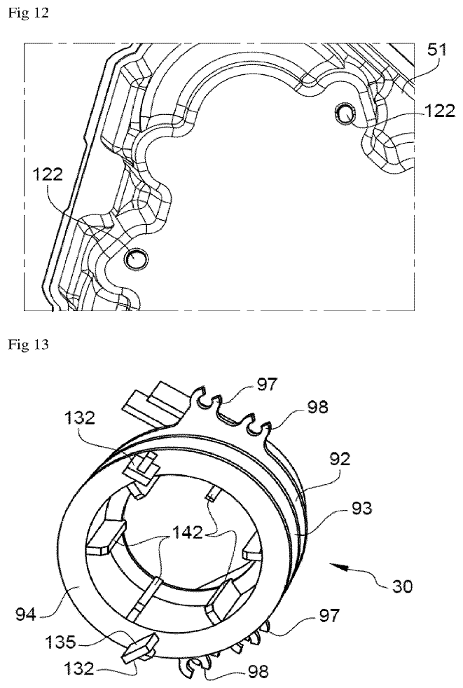

FIG. 12 shows the body of the casing of the transformer on which the support for electrical conductors of FIG. 11 is held,

FIG. 13 is a view similar to FIG. 11 and also shows ribs allowing this support to extend away from the portion of the magnetic circuit on which it is mounted,

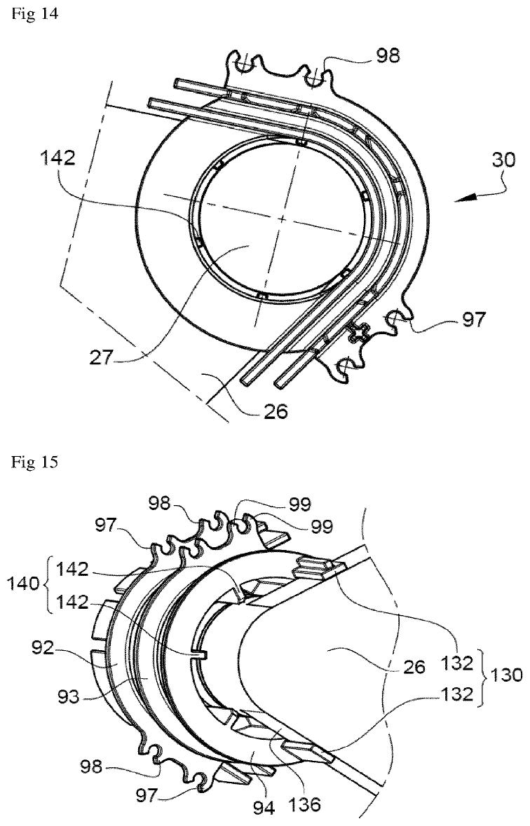

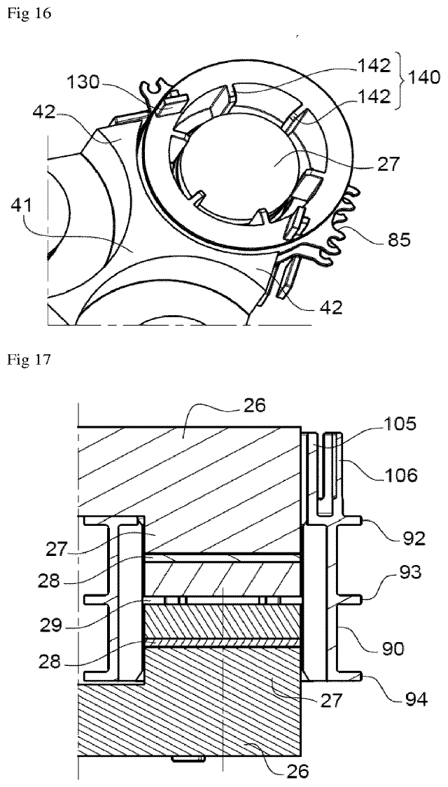

FIG. 14, FIG. 15 and FIG. 16 are views similar to that of FIG. 13 when the support for electrical conductors is mounted on the portion of the magnetic circuit,

FIG. 17 is a cross-sectional view of FIG. 16,

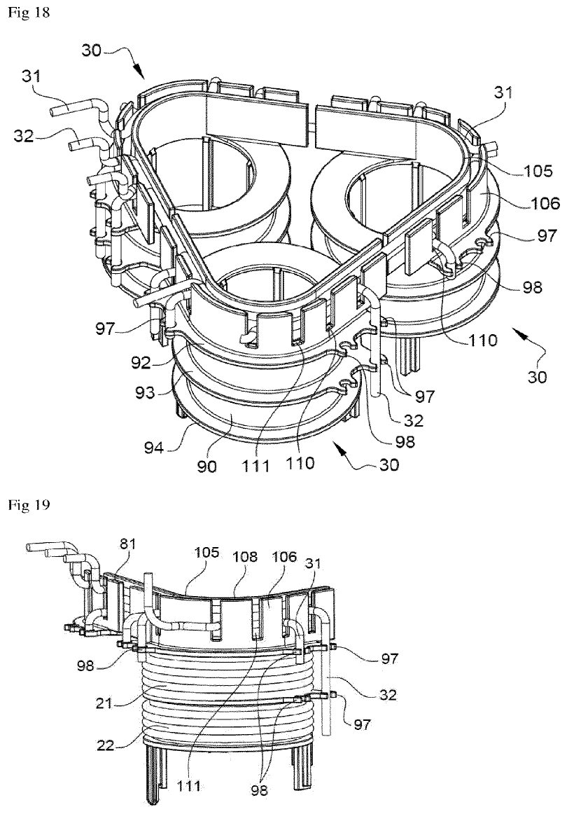

FIG. 18 shows three supports for electrical conductors of the transformer and their electrical conductors, without the magnetic circuit,

FIG. 19 shows, on its own, one of the three supports for electrical conductors of FIG. 18 with its electrical conductors, and

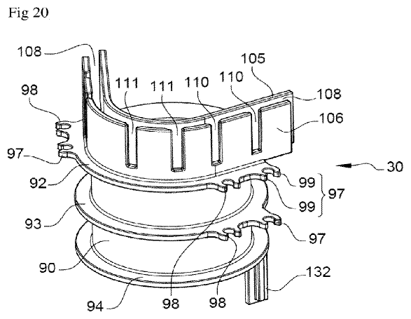

FIG. 20 shows the support for electrical conductors of FIG. 19 without its electrical conductors.

FIG. 1 shows part of the electrical circuit 1 of a component for supplying electric power to a vehicle electrical energy storage unit. This component is also called a “charger”. The electrical energy storage unit, not shown in this FIG. 1, is, for example, a battery, which can have a nominal voltage greater than 60 V, for example greater than or equal to 300 V, 400 V, 800 V, or even 1000 V.

The circuit 10 receives at its input an AC voltage from a network which is not shown and which is three-phase here. A rectifier which converts this AC voltage into a DC voltage and, where applicable, also performs a power factor correction function is arranged upstream of a DC bus 11. An insulated voltage converter 12, in this case a DC/DC converter, is arranged downstream of this DC bus, from the electrical network. This converter 12 comprises, in a known manner, an inverter 14, a three-phase transformer 15, and a rectifier 16 providing the vehicle with a DC voltage that is isolated from the electrical network. As can be seen in FIG. 1, the three-phase transformer 15 is connected to both the rectifier 16 and the inverter 14 by a block of inductors 17 and a block of capacitors 18, in such a way as to define a CLLLC structure. Other structures are, of course, possible, such as an LLC, CLLC, LC or CL structure.

As can be seen in FIG. 1, each phase has a primary winding 20 and a secondary winding 21 inductively coupled to one another, and the primary windings 20 are star-connected and the secondary windings 21 are also star-connected.

The three-phase transformer 15 comprises, in the example considered, a magnetic circuit 22 comprising a first part 23 and a second part 24. Each part 23, 24 comprises: a base 26 of substantially triangular contour, and three studs 27 each extending in the direction of the base 26 of the other part of the magnetic circuit 22. Each base 26 in this case has a contour defining an equilateral triangle.

The transformer 15 further comprises three supports 30 for electrical conductors 31, 32, with each support 30 in this case being mounted on two facing studs 27 respectively belonging to one and to the other of the portions 23, 24 of the magnetic circuit. Two electrical conductors 31, 32 linked to one and the same support 30 have a portion defining a primary winding 20 and a portion defining a secondary winding 21, respectively. These electrical conductors 31, 32 are, for example, Litz wire.

As can be seen in FIG. 2, the three supports 30 for electrical conductors 31, 32 are positioned so as to define an equilateral triangle.

The transformer 15 further comprises a casing 50 comprising a body 51 closed off by a cover 52, which are visible in FIGS. 4 and 6. This body 51 and this cover 52 are, for example, made of metal, for example of aluminum. The supports 30 and the magnetic circuit 22 are arranged inside the casing 50. The body 51 is filled with a resin that can be polymerized in order to harden and immobilize (“potting”) the components arranged inside the body. The body 51 comprises, in the example in question, a bottom wall and a side wall extending from the bottom wall and interposed between the bottom wall and the cover 52. The cover 52 in this case has a plate shape.

As can be seen in FIGS. 4 and 6, the casing 50 also has a triangular contour, being more specifically an equilateral triangle in this case. The casing is, in the example in question, formed only of the body 51 and the cover 52 but the invention is not limited to a casing 50 made up of two parts.

As can be seen in FIG. 3, each stud 27 defines a specific air gap 28, for example, via an area of the stud 27 filled with non-magnetic material, such as a composite of epoxy resin reinforced with glass fiber (FR4) or of ceramic. This area occupied by this non-magnetic material defines, for example, a whole slice of the stud. Several segments are, for example, assembled with this area of the stud 27 to form this stud 27.

As can be seen in FIG. 3, an additional air gap 29 is present between the facing ends of two studs 27 belonging to different parts 23, 24 of the magnetic circuit 22, respectively. Thus, in the example of the magnetic circuit 22 considered, each magnetic field allowing inductive coupling between a primary winding 20 and a secondary winding 21 crosses exactly three air gaps.

Still in FIG. 3, it can be seen that the magnetic circuit 22 of the example considered comprises a central leg 40 supported by one of the parts 23, 24 of the magnetic circuit 22.

This central leg 40 here is made in one piece with the part 23 of the magnetic circuit 22 which bears it.

It can be seen in FIG. 3 that the central leg 40 extends, in this example, continuously between two ends, each being in contact with one of the bases 26 of the magnetic circuit 22, such that no air gap is provided in the central leg 40.

As can also be seen in FIG. 3 or in FIG. 16, the central leg 40 has a core 41 and three protrusions 42 extending from this core 41, each protrusion 42 extending between two neighbouring studs 27 borne by one and the same part of the magnetic circuit.

As can be seen in FIG. 3, in the example considered, each stud 27 has a circular exterior contour, and each protrusion 42 of the central leg 40 here has a rounded wall facing the studs 27.

As can be seen in FIG. 2, the three-phase transformer 15 comprises a connection terminal block 45. This connection terminal block 45 is attached to one side of the casing 50 of the three-phase transformer 15. As can be seen in FIG. 2, the terminal block 45 in this case defines six terminals 60 for connecting the three-phase transformer 15 to the rest of the electrical circuit 10, with these terminals 60 being schematically shown in FIG. 1. These terminals 60 in this case come into contact with electrical tracks of an electronic board, not shown.

As can be seen in FIG. 2, the connection terminal block 45 has an elongate shape, and the six terminals 60 are in this case arranged in a row.

The various elements of the terminal block 45 according to the example of an embodiment shown will now be described with reference to FIGS. 7 to 9.

The terminal block 45 here comprises a body 61 and a plurality of electrically conductive bars 62, each terminal 60 being defined by a portion 63 of a bar. Each portion 63 is flat in this case, so as to come into contact with an electrical track of the aforementioned electronic board. The body 61 may be made of plastic, for example of PBT, PA, etc.

Each electrically conductive bar 62 has, for example, a portion 65, opposite the portion 63 defining the terminal, which is electrically connected to one of the electrical conductors 31, 32, here via a hollow sleeve 66 inside which the conductor 31, 32 is inserted, for example attached by crimping or welding.

Each electrically conductive bar 62 locally comprises a hole 67 and this electrically conductive bar 62 is attached to the body 61 by means of a screw 68 received in this hole 67. The body 61 in this case comprises six housings 69, and each of these housings receives an insert 70 that houses a hole 71, with the aforementioned screw 68 being received in an insert hole 71. Thus, the electrically conductive bar 62 is attached to the body 61 via the screw 68 and the insert 70 received in the housing 69. Each insert 70 may be made of metal, in particular of steel. As a variant, each insert is made of composite material. Six inserts are provided, for example, and, in the example considered, all these inserts 70 have the same shape and the same dimensions. Each screw 68 may, in addition to ensuring the attachment of an electrically conductive bar 62 to the body 61, also ensure the attachment of the electrically conductive bar 62 to the electronic board which is not shown.

As can be seen in FIG. 8, each insert 70 may define a positioning relief 73 for positioning the portion 63 of the electrically conductive bar defining the hole 67. This positioning relief 73 is, for example, a flat part of circular shape.

As can be seen in FIGS. 2, 7 and 8, the exterior wall of each housing 69 may house a recess 75 able to accommodate an end portion 64 of the electrically conductive bar 62 in order to ensure correct positioning of this bar on the body 61 and to prevent any relative rotation between this bar and this body.

In another example of an embodiment that has not been shown, the body 61 comprises a plurality of housings 69 which receive the screws 68 directly, in the absence of an insert 70. In this other example of an embodiment, the electrically conductive bar 62 is attached to the body 61 directly via the screw 68, without an intermediate piece.

As can be seen in FIGS. 4 and 5, each support 30 for electrical conductors may incorporate a holding system 80 for holding the cover 52 on this support 30.

Each support 30 comprises, for example, a single pin 81 protruding relative to the rest of the support 30 along the longitudinal axis of the latter. As a variant, only two of the three supports of the transformer 15 comprise a pin 81, the third support 30 not having said pin.

FIG. 5 shows a pin 81 in detail, it being possible for the latter to have a cruciform section perpendicular to the longitudinal axis of the support. Each pin 81 of a support 30 for electrical conductors is, in the example considered, received by force in an opening made in the cover 52, as can be seen in FIG. 4. The relative arrangement of the pins 81 of the supports 30 makes it possible to immobilize the cover 52.

As can be seen in FIG. 5, the holding system 80 for holding the cover 52 on the sup-port 30 may extend along the longitudinal axis of the support 30 on the same side of the support 30 as a guiding system 85 for guiding electrical conductors, which will be described with reference to FIGS. 18 to 20.

In these FIGS. 18 to 20, the holding system 80 is not shown, it being possible for the guiding system 85 to be present without necessarily the holding system 80 being present.

As can be seen in FIG. 18, each electrical conductor 31, 32 supported by a support 30 of the transformer 15 may be guided outside the winding 20, 21 that it defines.

In the example considered, each of these conductors 31, 32 is guided by the guiding system 85 beyond each of the ends of the electrical winding 20, 21 that it defines. As already mentioned above, the first ends of the electrical conductors may form an output towards the electrical circuit 10 outside the transformer 15, and three of the second ends of the electrical conductors may lead towards a common point via a star connection to the primary, and three others of these second ends of the electrical conductors may lead towards a common point via another star connection to the secondary.

The support 30 for the two electrical windings 20, 21 comprises:
a wall 90 around which the electrical windings 20, 21 are arranged, and this wall 90 defines, in the example considered but in a non-limiting manner, a hollow cylinder of circular cross section, and
three rims 92, 93, 94 offset along the longitudinal axis of the support such that one of the electrical windings 31 is arranged between the first 92 and the second 93 rim and such that the other of the electrical windings 32 is arranged between the second 93 and the third 94 rim, as is clearly visible in FIG. 2 for example. The gap between two consecutive rims 92, 93 and 93, 94 is constant in the example considered.

The guiding system 85 acts on the electrical conductors, on the one hand via clips 97 and 98, and on the other hand via additional walls 105 and 106.

In the example of FIGS. 18 to 20, the guiding system 85 comprises, for each electrical conductor 31, 32, on the one hand a first clip 97 interacting with this electrical conductor 31, 32 beyond the first end of the electrical winding 20, 21 that it defines. Such a clip 97 has, for example, two curved arms 99 in such a way as to fit closely around an area of the contour of this end of the electrical conductor, as shown in FIG. 18 or 20. In this case, the contour is circular. Each clip 97 is, for example but in a non-limiting manner, made in one piece with the rest of the support 30 for electrical conductors. As explained above, each first clip 97 interacts, for example, with a portion of the electrical conductor 31, 32 on the way towards a connection terminal 60.

The guiding system 85 comprises, on the other hand, a second clip 98 interacting with the electrical conductor beyond the second end of the electrical winding that it defines, these first 97 and second 98 clips coming one after another along one of the first 92, second 93 and third 94 rims. As explained above, each second clip 98 interacts, for example, with a portion of the electrical conductor 31, 32 on the way towards a common point of a star connection.

More precisely, in the example considered:
the first rim 92 comprises two first clips 97 which each respectively interact with one of the electrical conductors 31, 32 beyond the first end of the electrical winding 20, 21 that it defines, and two second clips 98 which each respectively interact with an electrical conductor beyond the second end of this electrical winding 20, 21, and
the second rim 93 comprises a first clip 97, arranged beneath a first clip 97 of the first rim 92, and a second clip 98, arranged beneath a second clip 98 of the first rim. The clips borne by the second rim 94 make it possible to guide the electrical conductor 32 outside the electrical winding arranged between the second rim 93 and the third rim 94.

As can be seen in FIGS. 18 to 20, there are two pairs of clips each formed of a first clip 97 and of a second clip 98 along the rim 92 and the gap between two pairs of clips is greater than the distance between two clips of the same pair.

As can also be seen in these FIGS. 19 and 20, the clips 97, 98 borne by the second rim 93 are aligned along the axis of the cylindrical wall 90 with clips 97, 98 borne by the first rim 92.

The two additional walls 105 and 106 of the guiding system 85 will now be described. These two additional walls 105 and 106 here are offset so as to define between them a guiding channel 108 receiving in a stacked manner the electrical conductors 31, 32 outside the windings 20, 21 that they define. The channel 108 in this case has a constant dimension.

These additional walls extend, in the example considered, on both sides of an arc-shaped portion of the first rim 92, protruding axially beyond this first rim 92. In the area overlapping with this first rim 92, the additional walls 105 and 106 each define an arc-shaped portion, the wall 106 having a radius that is greater than the wall 105, as is also visible in FIG. 17.

It can be seen in FIGS. 18 to 20 that the wall 106 comprises first openings 110 for the passage of the electrical conductors 31, 32 towards the electrical winding 20, 21 that it defines, and second openings 111 through which no electrical winding passes. It can be seen that the first openings 110 are arranged radially facing a clip 97, 98.

In the example of FIGS. 10 to 12, each support 30 for electrical conductors 31, 32 also incorporates a holding system 120 for holding on the body 51 of the casing 50. This holding system 120 here comprises a pin 121 having, in this example, a cruciform section perpendicular to the longitudinal axis of the support. This pin 121 extends axially away from the rest of the support 30 from the third rim 94. As can be seen in FIGS. 10 and 12, each pin 121 is received by force in an opening 122 made in the body 51 of the casing 50.

This holding system may ensure that the magnetic circuit 22 is immobilized on the body 51 of the casing before the resin contained in this casing 50 polymerizes.

When such holding systems 120 exist, they may or may not be combined with the holding systems 80 and the guiding systems 85 mentioned above. As can be seen in FIGS. 10 to 12, each holding system 120 may thus extend axially from one side of the support 30 while the holding system 80 and the guiding system 85 extend axially from the opposite side of the support 30.

A functionality which may be integrated into all or some of the supports 30 for electrical conductors 31, 32 will now be described with reference to FIGS. 13 to 15. A holding system 130 for holding a support 30 for electrical conductors 31, 32 on the magnetic circuit 22 is thus provided. This holding system 130 is in the form of two blocks 132 protruding relative to the rest of the support 30. When the holding system 120 is provided, these systems 130 and 120 may extend axially from the same side of the support, the pin 121 and a block 132 being in particular arranged side-by-side as can be seen in the example of FIG. 11.

Each block 132 in this case defines a surface 135 coming into contact with a surface 136 of a base 26 of the magnetic circuit 22. The surfaces 135 and 136 are flat in this case. Each block 132 is, for example, supported by a reinforcement 133, as can be seen in FIG. 11.

As can be deduced from FIG. 15, the interaction between the two blocks 132 of a sup-port 30 and the base 26 may ensure that the support 30 is rotatably immobilized on the magnetic circuit 22.

Another functionality which may be integrated into all or some of the supports 30 for electrical conductors 31, 32 will now be described with reference to FIGS. 13 to 16. It can be seen in these figures that the cylindrical wall 90 of the support 30 comprises ribs 142 extending away from the wall 90 in the direction of the stud 27 on which this support is mounted.

In the example considered, six ribs 142 are provided but the invention is not limited to a specific number of ribs 142. These six ribs 142 thus make up a spacing system 140 for spacing the cylindrical wall 90, and therefore the electrical windings 20, 21 that it bears, from the stud 27.

It can be seen in FIGS. 13 to 16 that all the ribs 142 may have the same shape and be distributed uniformly around the stud 27.

It can also be seen in these figures that each rib 142 may extend continuously along the axis of the support 30 from the first rim 92 up to the third rim 94.

In a variant which is not shown, all or some of the ribs extend discontinuously along the axis of the support 30.

As can be seen in FIG. 16, each rib 142 does not extend, for example, up to the stud 27 on which the support 30 is mounted. An empty space ensuring easy mounting thus remains present between each end of a rib facing the stud 27 and this stud 27.

As already mentioned, each support 30 for electrical conductors 31, 32 may be made in one piece.

When this support 30 incorporates:
the ribs 142, and/or
the holding system 80 for holding the cover 52 on the support, and/or
the guiding system 85 for guiding electrical conductors, and/or
the holding system 120 for holding the support on the body 51 of the casing, and/or
the holding system 130 for holding the support on the magnetic circuit 22, all these systems may or may not be made in one piece with the rest of the support 30. In one particular example, the support 30 is thus in one piece and has all or some of the aforementioned functionalities.

The invention is not limited to the examples that have been described above.

1. A transformer for an isolated voltage converter comprising:
a casing,
a magnetic circuit,
two electrical conductors each having a portion arranged around one and the same portion of the magnetic circuit, each of said portions forming a winding between a first and a second end, these two windings being inductively coupled to one another via the magnetic circuit, and
a support for the two electrical windings arranged between said electrical conductors and said portion of the magnetic circuit,
wherein the support incorporates a holding system for holding on the casing, in particular on the body of the casing and in that the holding system comprises at least one pin protruding relative to the rest of the support.

2. The transformer as claimed in claim 1, the pin having a cruciform section perpendicular to the longitudinal axis of the support.

3. The transformer as claimed in claim 1, the holding system comprising a single pin.

4. The transformer as claimed claim 1, the pin being forcibly received in an opening provided in the casing, notably in the body of the casing, in such a way as to hold the support on the casing.

5. The transformer as claimed in claim 1, the casing comprising a body and a cover closing off the body the body, comprising: a bottom wall, and a side wall extending from the bottom wall and interposed between the bottom wall and the cover, the cover having a plate shape.

6. The transformer as claimed in claim 1, the support comprising a wall defining a hollow cylinder, in particular of circular cross section, around which the electrical windings are arranged, and the pin extending along the axis of this cylinder.

7. The transformer as claimed in claim 6, the support comprising three rims offset along the axis of the cylinder, such that one of the electrical windings is arranged between the first and the second rim and such that the other of the electrical windings is arranged between the second and the third rim, the pin extending axially away from the rest of the support, from the third rim.

8. The transformer as claimed in claim 1, the support and the holding system being made in one piece.

9. The transformer as claimed in claim 1, the support also incorporating a holding system for holding on the magnetic circuit, in particular one or more blocks protruding relative to the rest of the support, the holding system for holding on the casing and the holding system for holding on the magnetic circuit being or not being circumferentially offset.

10. The transformer as claimed in claim 9, the holding system for holding on the casing and the holding system for holding on the magnetic circuit implementing reliefs extending along the axis of the support away from the rest of the support.

11. The transformer as claimed in claim 1, defining a three-phase transformer for an isolated voltage converter, comprising three supports for electrical windings each support being arranged around a portion of the magnetic circuit and supporting two windings inductively coupled to one another via the magnetic circuit, the supports defining in particular a geometric pattern of an equilateral triangle.

12. The transformer as claimed in claim 11, only some of the three supports for electrical windings incorporating a holding system for holding on the casing, the holding system comprising at least one pin protruding relative to the rest of said support.

13. The transformer as claimed in claim 11, each support for electrical windings incorporating a holding system for holding on the casing.

14. The transformer as claimed in claim 12, each support for electrical conductors incorporating a holding system for holding on the magnetic circuit, these holding systems being arranged relative to one another in such a way as to immobilize the magnetic circuit relative to the casing.

15. A component for supplying electric power to a vehicle electrical energy storage unit, comprising the transformer as claimed in claim 1.

16. The transformer as claimed in claim 2, the holding system comprising a single pin.

17. The transformer as claimed claim 2, the pin being forcibly received in an opening provided in the casing, notably in the body of the casing, in such a way as to hold the support on the casing.

18. The transformer as claimed in claim 2, the casing comprising a body and a cover closing off the body, the body comprising: a bottom wall, and a side wall extending from the bottom wall and interposed between the bottom wall and the cover, the cover having a plate shape.

19. The transformer as claimed in claim 2, the support comprising a wall defining a hollow cylinder, in particular of circular cross section, around which the electrical windings are arranged, and the pin extending along the axis of this cylinder.

20. The transformer as claimed in claim 2, the support and the holding system being made in one piece.
